(19) United States
(12) Patent Application Publication
(10) Pub. No.: US 2015/0057389 A1
(43) Pub. Date: Feb. 26, 2015

(54) HYDROGEL AND SILICONE HYDROGEL DEVICES INCLUDING POLYMERIZED SURFACTANTS

(71) Applicant: UNIVERSITY OF FLORIDA RESEARCH FOUNDATION, INC., GAINESVILLE, FL (US)

(72) Inventors: ANUJ CHAUHAN, GAINESVILLE, FL (US); LOKENDRAKUMAR CHAINROOM KUMAR BENGANI, GAINESVILLE, FL (US)

(21) Appl. No.: 14/466,584

(22) Filed: Aug. 22, 2014

Related U.S. Application Data
(60) Provisional application No. 61/869,431, filed on Aug. 23, 2013.

(51) Int. Cl. G02B 1/04

(52) U.S. Cl. CPC G02B 1/043
USPC 523/107; 523/106

(57) ABSTRACT

A wettable hydrogel or a silicone hydrogel device includes a polymerized surfactant incorporated into the gel by addition to a gel, on average, of a single ethylenic functionality of the precursor polymerizable surfactant in the polymerization mixture. The attached polymerized surfactant provides improved lubricity to the hydrogel or silicone hydrogel device. Alternately, a wettable hydrogel or a silicone hydrogel device can be formed by soaking a preformed hydrogel or a silicone hydrogel device in a solution of the polymerizable surfactant and a radical initiator and promoting the polymerization of the polymerizable surfactant and available polymerizable groups on or in the device. The wettable hydrogel or a silicone hydrogel device can be a contact lens.

### CROSS-REFERENCE TO RELATED APPLICATION

The present application claims the benefit of U.S. Provisional Application Ser. No. 61/869,431, filed Aug. 23, 2013, which is hereby incorporated by reference herein in its entirety, including any figures, tables, or drawings.

### BACKGROUND OF INVENTION

Almost 50% of the 35 million contact lens wearers in the North America experience some dryness and discomfort. Discomfort leads wearers to return to glasses. The exact mechanisms that cause the dryness and discomfort are complex and not even completely understood. Yet certain properties of the lenses impact both dryness and discomfort. For instance, contact lenses with poor wettability and high water content appear to have an increased potential for causing dryness. Poor wettability can be attributed to rapid breakup of the tear film on the lens surface promoting evaporation. A highly wettable lens surface can enable a stable pre-lens rear film (PLTF), which is necessary for good vision. Additionally, a stable PLTF can provide a lubricating effect to ease the sliding between the eyelid and lens. A continuous tear film between the posterior surface of lens and cornea is a necessary criterion for biocompatibility, which is readily fulfilled with a highly wettable lens.

The correlation of the dryness symptoms with high water content can be rationalized by higher water content lenses have a high tendency to dehydrate. High water content lenses can be comfortable when designed to promote minimal dehydration. Contact lens discomfort may be caused by the interaction of the ocular epithelia with the lens. Therefore, surface lubricity is expected to be an important parameter for comfort. Lubricity is characterized by the coefficient of friction between two surfaces, for example, the contact lens and the eye.

Efforts to improve wettability have focused on incorporation of highly hydrophilic monomers, plasma surface treatments, and the addition of internal wetting agents, such as poly(vinyl alcohol) (PVA) or poly(vinylpyrrolidone) (PVP). Whereas low molecular PVA diffuses from lenses, high molecular weight PVP loaded in lenses remains trapped but it is believed to partially diffuse to the surface to increase wettability of the lens. PVA and PVP have been used in artificial tears and rewetting drops for contact lenses. Surfactants that have been added to rewetting drops and lens care solutions have been found to be beneficial. Adsorbed and absorbed surfactant desorb with time, which can lead to reduced comfort over time.

Recently, Linhardt et al., U.S. Pat. No. 8,377,464 has disclosed polymerizable surfactants that are bis-acrylate or bis-methacrylate polyoximers or tetrakis-acrylate or tetrakis-methacrylate polyoxamines and their inclusion into contact lenses. With appropriate formulations some lenses with little reduction in transparency (>98%) have been formed with surfactants included at levels of about 5% or less in the polymerization mixture. No significant change in mechanical properties was observed, and polyether was observed on the surface of the lenses. No disclosure indicated any reduction of friction, wettability or improvement in comfort. McCabe et al. U.S. Pat. No. 8,450,387 has disclosed the use of hydroxyl and oligoethyleneoxide substituted mono- and bis-acrylate or methacrylate silicone comprising monomers to improve internal wetting. Little differences in surface properties, such as contact angle are indicated. One must consider the potential toxicity of surfactants desorbed into the eye. To this end effective polymerized surfactant comprising lenses remain a need.

### BRIEF DESCRIPTION OF DRAWINGS

FIG. 1 shows the structure of the polymerizable surfaces for preparation of contact lenses according to embodiments of the invention where A is a base structure for a Noigen series and B is a base structure of a Hitenol series polymerizable surfactant.

FIG. 2 shows composite transmittance spectra of p-HEMA gels, according to embodiments of the invention, with different polymerized surfactants: a) N30 b) N10 and c) H30.

FIG. 3 shows microscope images of sessile drops on a) p-HEMA gels, and b) p-HEPA gels with different amounts of polymerized surfactants N30 or N10, as indicated, according to embodiments of the invention.

FIG. 4 is a plot of the dependence on the contact angle on the amount of polymerized surfactant in the HEPA gels, according to embodiments of the invention.

FIG. 5 shows microscope images of sessile drops on the contact angle of Acuvue lens that are unmodified (left) and had polymerizable surfactant incorporated (right), according to an embodiment of the invention, where contact angle for the unmodified lens is about 70° and about 0° for the surfactant incorporated lens.

FIG. 6 shows microscope images of sessile drops on the contact angle of Acuvue TruEye lens that are unmodified (left) and had polymerizable surfactant incorporated (right), according to an embodiment of the invention, where contact angle for the unmodified lens is about 70° and about 0° for the surfactant incorporated lens.

FIG. 7 is a plot of the dependence on the surface friction on the amount of polymerized surfactant in the HEPA gels, according to embodiments of the invention.

FIG. 8 is a plot of the time for water uptake in p-HEMA and p-HEMA gels with polymerized surfactant, according to embodiments of the invention.

FIG. 9 shows plots of the frequency dependent storage modulus for p-HEPA gels with polymerized surfactant, according to embodiments of the invention for a) N30 and b) N10 containing gels.

FIG. 10 shows the relative ion permeability of p-HEMA, N30-30%-3X and N10-8% gels and an insert of the plot of ion permeability increase with the water content increase for p-HEMA gels with polymerized surfactants, according to an embodiment of the invention.

### DETAILED DISCLOSURE

Embodiments of the invention are directed to hydrogels and silicon hydrogel, such as those used for contact lenses, with covalently attaching surfactants. Inclusion of the polymerized surfactants in the gel matrix significantly increases the lenses wettability and lubricity, relative to a lens free of the surfactants. Covalent attachment is achieved by adding polymerizable surfactants with a single ethylenic polymerizable functionality, or a mixture of polymerizable surfactants with an average of one ethylenic polymerizable functionality per surfactant, to the monomer mixture, followed by UV promoted curing to the gel. Advantageously, the use of a mono polymerizable unit in the surfactant permits surfactant at an interface to freely extend from the interface, which is needed for the group to display properties of a surfactant. In an embodiment of the invention, the ethylenic bond is that of a styrenic unit. The ethylenic bond of the styrenic unit can be unsubstituted, α-substituted, or β-substituted, for example, β-substituted with a methyl group. Having a styrenic unit or other unit with a limited conjugation length, permits the polymerizable surfactant to also provide UV protection, even UVA and UVB, because of the included non-polymerizable conjugated units. The polymerizable surfactant can be prepared to comprise a UVA and/or UVB chromophore. For example, the exemplary styrenic based polymerizable surfactants can provide UVB and some UVA blocking. Although exemplary embodiments of the invention are to hydroxyethyl methacrylate (HEMA) lenses, the procedures and compositions disclosed herein are readily adapted to silicone hydrogel lenses, as can be appreciated by one of ordinary skill in the art.

The hydrogel and silicone hydrogel materials can be prepared from any monomers commonly employed for the preparation of contact lenses. Suitable hydrophilic monomers, which may be used separately for preparation of hydrogel lenses or in combination for the silicone hydrogels include, but are not limited to, for example: unsaturated carboxylic acids, such as methacrylic and acrylic acids; acrylic substituted alcohols, such as 2-hydroxyethylmethacrylate (HEMA), 2-hydroxyethylacrylate, and tetraethyleneglycol dimethacrylate (TEGDMA); vinyl lactams, such as N-vinyl pyrrolidone; vinyl oxazolones, such as 2-vinyl-4,4′-dimethyl-2-oxazolin-5-one; and acrylamides, such as methacrylamide and N,N-dimethylacrylamide (DMA). Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Hydrophilic monomers may be incorporated into such copolymers, including, methacrylic acid and 2-hydroxyethyl methacrylamide

Suitable silicone hydrogel materials include, without limitation, silicone hydrogels made from silicone macromers such as the polydimethylsiloxane methacrylated with pendant hydrophilic groups described in U.S. Pat. Nos. 4,259,467; 4,260,725 and 4,261,875; or the polydimethylsiloxane macromers with polymerizable functional described in U.S. Pat. Nos. 4,136,250; 4,153,641; 4,189,546; 4,182,822; 4,343,927; 4,254,248; 4,355,147; 4,276,402; 4,327,203; 4,341,889; 4,486,577; 4,605,712; 4,543,398; 4,661,575; 4,703,097; 4,740,533; 4,837,289; 4,954,586; 4,954,587; 5,034,461; 5,070,215; 5,260,000; 5,310,779; 5,346,946; 5,352,714; 5,358,995; 5,387,632; 5,451,617; 5,486,579; 5,962,548; 5,981,615; 5,981,675; and 6,039,913. The silicone hydrogels can also be made using polysiloxane macromers incorporating hydrophilic monomers such as those described in U.S. Pat. Nos. 5,010,141; 5,057,578; 5,314,960; 5,371,147 and 5,336,797; or macromers comprising polydimethylsiloxane blocks and polyether blocks such as those described in U.S. Pat. Nos. 4,871,785 and 5,034,461.

Silicone containing monomers which may be in the formulation of a silicone hydrogel of the present invention include oligosiloxanylsilylalkyl acrylates and methacrylates containing from 2-10 Si-atoms. Typical representatives include: tris(trimethylsiloxysilyl)propyl(meth)acrylate, triphenyldimethyl-disiloxanylmethyl(meth)acrylate, pentamethyldisiloxanyl-methyl(meth)acrylate, tert-butyl-tetramethyldisiloxanylethyl(meth)acrylate, methyldi(trimethyl-siloxy)silylpropylglycerylmeth)acrylate; pentamethyldisiloxanylmethyl methacrylate; hepta-methylcyclotetrasiloxymethylmethacrylate; heptamethylcyclotetrasiloxypropylmethacrylate; (trimethylsilyl)decamethylpentasiloxypropyl methacrylate; and dodecamethylpentasiloxypropyl methacrylate.

Other representative silicone-containing monomers which may be used for silicone hydrogels of the present invention include silicone-containing vinyl carbonate or vinyl carbamate monomers such as: 1,3-bis[4-vinyloxycarbonyloxybut-1-yl]tetramethyldisiloxane; 3-(trimethylsilyl)propylvinylcarbonate; 3-(vinyloxycarbonylthio)propyl[tris(trimethylsiloxy)ilane]; 3-[tris(trimethylsiloxy)silyl]propylvinyl carbamate; 3-[tris(trimethylsiloxy)silyl]propyl-allylcarbamate; 3-[tris-(trimethylsiloxy)silyl]propylvinyl carbonate; t-butyldimethylsiloxethyl vinyl carbonate; trimethylsilylethyl vinyl carbonate; and trimethylsilylmethyl vinyl carbonate. Polyurethane-polysiloxane macromonomers (also sometimes referred to as prepolymers), which have hard-soft-hard blocks like traditional urethane elastomers, may be used. Examples of such silicone urethanes that may be included in the formulations of the present invention are disclosed in a variety or publications, including Lai, “The Role of Bulky Polysiloxanylalkyl Methacrylates in Polyurethane-Polysiloxane Hydrogels,” Journal of Applied Polymer Science, Vol. 60, 1193-1199 (1996).

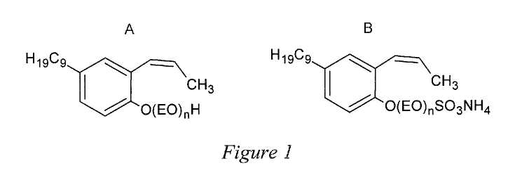

In exemplary embodiments of the invention, Noigen RN-10™ (N10), Noigen RN30™ (N30) and Hitenol BC30™ (H30), as shown in FIG. 1, can be used as the polymerizable mono-ethylenic surfactant. The polymerizable surfactant can be any mono-ethylenic functionality, including, but not limited to, acrylic, methacrylic, substituted acrylic, acrylamide, methacrylamide, styrene, dienyl, isoprenyl, and maleic acid imide. In some formulations of the hydrogel or silicone hydrogel, the ethylenic group may be the same or different than the ethylenic groups of other monomers and multifunctional monomers in the formulation such that the surfactant is randomly situated throughout the resulting phases of the device into which they partition. In other formulations it can be advantageous that the ethylenic group be different to promote isolation or aggregation, as desired, of the ethylenic group comprising surfactant within at least a phase of the hydrogel or silicone hydrogel.

In an embodiment of the invention, the surfactant can be derived from any polyethylene oxide comprising surfactant that can be primarily or exclusively monofunctionalized with a radically polymerizable ethylenic group. Particularly when the free surfactant is non-toxic, the surfactant can be one with a plurality of functional groups that can undergo reaction with an ethylenic group precursor to form an ethylenic group substituted surfactant. The surfactant can be used with a controlled amount of the ethylenic group precursor such that on average the ethylenic group substituted surfactant has less than two, for example, less than 1.5, less than 1.25, less than 1.1, 1, or less than 1 ethylenic group attached to the surfactant. Hence, upon incorporation of this polymerizable surfactant into the hydrogel or silicone-hydrogel, a majority of the surfactants bound into the gel has a single point of attachment into the gel, regardless of the degree of polymerization achieved during the polymerization of ethylenic groups in the gel. Unincorporated surfactant can be washed from the hydrogel or silicone-hydrogel prior to use of the device, if desired. When the surfactant is non-toxic, washing may not be needed. Many appropriate surfactants include polyethylene oxide polymers and copolymers, where at least one end is not an OH, NH₂, NHR, or other group that can be readily used as a complementary ethylenic group reagent for formation of an ethylenic group substituted surfactant. Other surfactant polymer repeating units that can be used are vinyl alcohol, pyrrolidone, sugars, starches, or other water soluble polymers from natural or synthetic sources. The surfactant can include ionic groups, and can be a combination of a water soluble polymer with an ionic group. The molecular weight and structure of the surfactant can vary, limited by the polymerizable surfactant's miscibility with the other components used to polymerize into the hydrogel or silicone hydrogel device. In some embodiments of the invention, it is advantageous that the molecular weight of the surfactant is moderate or low, with degrees of polymerization of ethylene oxide or other surfactant repeating groups being less than about 50, for example, less than about 30, less than about 20, or less than about 10. Proper selection of the surfactants size and the degree of inclusion into a gel formulation is made to balance the desirable surface properties achieved with retention of desired bulk material properties. A combination of polymerizable surfactants can be used, and the combination can include polymerizable surfactants with different surfactant portions or different ethylenic groups, In exemplary embodiments of the invention, the ethylenic group substituted surfactant is a Noigen RN-10™ (N10), Noigen RN30™ (N30) or Hitenol BC30™ (H30) shown in FIG. 1.

The contact angle and coefficient of friction of polymerized surfactant comprising hydrogels and silicone hydrogels, for example, the exemplary pHEMA hydrogels, display a significant lowering due to the presence of incorporated polymerized surfactants, yet a very high >98% retention of transparency is found for the device. An improved wettability and lubricity, and thus improved comfort, can be achieved in this fashion. Although, N10 and N30 Noigen surfactants provide for a decreased contact angle and friction coefficient, under the polymerization conditions and compositions employed, N10 surfactant appears to achieve a greater degree of lowering, and it was observed that it permitted a higher degree of incorporation into the hydrogel. The surfactant incorporation does not appear to significantly impact any critical bulk property and so its incorporation into the lenses could improve surface properties without any adverse effect on the bulk properties.

In another embodiment of the invention, a hydrogel contact lens or a silicon hydrogel contact lens can be modified by preparing a solution of the polymerizable surfactant and an initiator for radical polymerization. This solution is then contacted with a hydrogel or silicon hydrogel device under conditions where initiation of polymerization does not result for a sufficient period of time to infuse the polymerizable surfactant and initiator into and/or onto the device. The device is the placed in an environment that promotes initiator decomposition and the radical polymerization of the polymerizable surfactant and available ethylenic groups in the gel network of the device.

### Methods and Materials

### Materials

2-Hydroxyethyl methacrylate (HEMA) monomer and ethylene glycol dimethacrylate (EGDMA) were purchased from Sigma-Aldrich Chemicals (St Louis, Mo.). Sodium chloride (99.9+%) was purchased from Fisher Scientific (Fairlawn, N.J.). 2,4,6-trimethylbenzoyl-diphenyl-phophineoxide (Darocur® TPO) was kindly provided by Ciba (Tarrytown, N.Y.). Noigen RN-10™ (N10), Noigen RN30™ (N30) and Hitenol BC30™ (H30) were kindly provided by Montello Inc. (Tulsa, Okla.). All the chemicals were reagent grade and were used without further purification.

Preparation and Purification of p-HEMA Gels with Polymerizable Surfactants

The structures of the three polymerizable surfactants used are shown in FIG. 1. The N10 and N30 belong to the Noigen series with values of 10 and 30 for n, respectively, while H30 belongs to the Hitenol series with n=30. The surfactant loaded gels were prepared by photo-polymerization of an aqueous solution of the surfactants, monomer (HEMA), cross-linker (EGDMA) and the initiator Darocur® TPO. The masses of HEMA, EGDMA, and the water were kept fixed, while the mass of the surfactant was increased to prepare gels with various surfactant loadings. The exact compositions of the solutions are included in Table 1. At higher surfactant loadings, the cross-linker content was increased to compensate the decrease in modulus. The solution was degassed to reduce the concentration of dissolved oxygen by bubbling nitrogen for 15 minutes. 12 mg of the photoinitiator (Darocur® TPO) was then added, accompanied by stirring at 750 rpm for 5 minutes to ensure complete dissolution of the initiator. The solution was then poured between two 5 mm thick glass plates that were separated from each other by spacers which were approximately 780, 240 and 100 μm in thickness. The mold was placed on Ultraviolet transilluminiator UVB-10 (UltraLum, Inc.) and the gel was cured by irradiating UVB light (305 nm) for 40 min. The gels were removed from the glass plates and cut into rectangular pieces of the desired size. The unreacted monomer was removed by soaking the gels in boiling de-ionized (DI) water for 3 hours, and subsequently soaking in fresh DI water for another 20 hours at room temperature.

TABLE 1
Composition of the polymerizing solutions

| | | Surfactant/ | Vol. | Vol. | Mass | Mass |
|---|---|---|---|---|---|---|
| | | HEMA | HEMA | Water | Surf | EGDMA |
| Gel name | surf | g/ml | ml | ml | g | μl |
| p-HEMA | None | 0 | 5.4 | 4 | 0 | 20 |
| N30-1% | N30 | 1 | 5.4 | 4 | 0.054 | 20 |
| N30-2% | N30 | 2 | 5.4 | 4 | 0.108 | 20 |
| N30-4% | N30 | 4 | 5.4 | 4 | 0.216 | 20 |
| N30-8% | N30 | 8 | 5.4 | 4 | 0.432 | 20 |
| N30-30%-3X | N30 | 30 | 5.4 | 4 | 1.62 | 60 |
| N30-30%-10X | N30 | 30 | 5.4 | 4 | 1.62 | 200 |
| N10-3.5% | N10 | 3.5 | 5.4 | 4 | 0.19 | 20 |
| N10-8% | N10 | 8 | 5.4 | 4 | 0.432 | 20 |
| N10-15%-3X | N10 | 15 | 5.4 | 4 | 0.81 | 60 |
| N10-30%-3X | N10 | 30 | 5.4 | 4 | 1.62 | 60 |
| N10-50%-3X | N10 | 50 | 5.4 | 4 | 2.7 | 60 |
| H30-2% | H30 | 2 | 5.4 | 4 | 0.108 | 20 |
| H30-8% | H30 | 8 | 5.4 | 4 | 0.432 | 20 |
| H30-30%-3X | H30 | 30 | 5.4 | 4 | 1.62 | 60 |

### Addition of Prepolymerized Surfactant Solution to the Polymerization Mixture

Aqueous surfactant was partially polymerized by exposing an aqueous solution to UV radiation. Specifically, 5.078 g of N10 was dissolved in 20 ml of water. Subsequently, 6 mg Darocur TPO was mixed with 4.81 g of the surfactant solution in a glass vial and placed on a UV-transilliuminator for 30 min. Separately, 5.4 ml HEMA was mixed 60 μl of EGDMA and bubbled with N₂ for 15 min. 6 mg of TPO was mixed with solution and the entire solution was added to the polymerized surfactant solution. The resulting solution was stirred at 600 rpm for 5 min. The solution was placed between glass plates and polymerized by following the process as described above and the polymerized gels were subjected to the same process of extraction. The gel prepared with the process described above is called polyN10-15%-3X as it has 15% surfactant prior to the extraction and thus the composition matches N10-15%-3X prepared by direct incorporation of the monomer. Similarly, another gel was formed with pre-polymerized surfactant with its composition matching N10-8% and thus labeled as polyN10-8%.

### Addition of Polymerizable Surfactants to Pre-Formed Commercial Contact Lenses

In order to enhance the wettability of commercial lenses, 1-Day Acuvue (HEMA based) and 1-Day Acuvue True Eye (Silicone based) lenses were utilized. Lenses were removed out of their packs with tweezers, soaked in water for 3 hr to remove any extractable materials, and then dried in air. Separately, 23 g N10 surfactant was added to a solution comprising of 33 ml water and 13 ml ethanol. Next 20 mg of Darocur TPO was mixed with 10 g of above mixture in a glass vial and then contact lenses were soaked in this mixture for a period of 5 days. The vials were covered with aluminum foil to minimize UV exposure. After the soaking period, the solution along with the soaked lenses were poured in a glass petri dish, covered and placed on a Ultraviolet transilluminiator UVB-10 (UltraLum, Inc.) and cured by irradiating UVB light (305 nm) for 1 hr. The lenses were removed, dried for a day and subjected to extraction process as described above.

### Hydrogel Characterization

### Surface Characterization

### Contact Angle

The wettability of the gels was characterized by measuring the contact angle between the surface and a sessile water drop with a Drop Shape Analyzer (DSA100, KRUSS) using the Tangent method. A hydrated 240 μm thick gel was placed on a glass slide and the surface was lightly wiped with a Kimwipe® to remove any excess water. A small drop of DI water was then placed on the surface and the volume was slowly increased incrementally, while measuring the contact angle for each drop volume.

### Surface Friction

The surface lubricity was characterized by measuring the friction between an iron ball and the surface using an in-house apparatus. A hydrated square piece of gel approx. 1.5×1.5 cm was placed on glass slide resting on an inclined plane whose angle could be precisely controlled. A metal ball weighing 0.264 g was placed on the gel and the angle of the inclined plane was gradually increased until the ball started rolling. The coefficient of friction was calculated as the tangent of the rolling angle. Four measurements were conducted for each gel and three gel samples were utilized with identical composition.

To measure contact angle on modified commercial lens, the lens was placed on a p-HEMA mold and the surface was lightly wiped with a Kimwipe® to remove any excess water. A small drop of DI water was then placed on the surface and the volume was slowly increased incrementally, while measuring the contact angle for each drop volume.

### Bulk Characterization

### Equilibrium Water Content (EWC)

After extraction, the gels were dried and weighed to obtain W_{dry}. The gels were then soaked in water for sufficient duration to achieve equilibrium. In some cases the gel weight was periodically measured during the swelling, while in most cases only the final equilibrium weight (W_{wet}) was measured. The surface of the gels was gently wiped with Kimwipes® before each measurement. The water content of the gels was determined by

$$\% EWC = \frac{( {W}_{wet} - {W}_{dry} )}{( {W}_{wet} )} \times 100. \qquad ( 1 )$$

### Transmittance

The transmittance of 100 μm thick hydrated gels (T(λ)) was measured using UV-Vis spectrophotometer (Thermospectronic Genesys 10 UV) at wavelengths ranging from 200 nm to 700 nm. The average transmittance from 600 nm to 700 was calculated to characterize the visual clarity. The UV absorbance spectra A=−log₁₀(T/100) was used to quantify the average concentration of the surfactant in the lens using the Beer Lambert's law, i.e., A=A_{HEMA} ε(λ)cl, where A_{HEMA} is the absorbance of the control HEMA gel, ε(λ) is the molar absorptivity, c is the concentration and 1 (=100 μm) is the path length. The absorbance spectra of hydrated 100 nm thick p-HEMA gel was measured to obtain A_{HEMA} and the molar absorptivity of the surfactant ε(λ) was determined by measuring the absorbance of aqueous surfactant solutions at a concentration of 0.01% (w/w) and using the Beer Lambert law with 1=1 cm.

### Mechanical Properties

The storage modulus of hydrated rectangular 780 μm thick gels was measured using a dynamic mechanical analyzer (DMA Q800, TA instruments) using a submersion tension clamp at room temperature. A preload force applied 0.01N and force track was 115% used and strain sweep tests were recorded to confirm the linear range at room temperature at 1 Hz. Subsequently, frequency dependent storage modulus and loss modulus was obtained by fixing the strain within the linear range.

### Ion Permeability

A circular hydrogel of 1.65 cm diameter was soaked in 3.5 ml of 1 M NaCl solution until equilibrium was achieved. The salt-loaded gel was then transferred into a well-mixed 27.5 ml DI water maintained at room temperature. The conductivity of the solution was periodically measured by Con 110 series sensor (OAKTON®) and the salt concentration was then determined through the calibration curve, which was linear with a slope of 8.58×10⁻⁶ M/μs. The dynamic salt concentration was fitted to a sink release model to calculate the effective ion diffusivity in the lens.

### Transmittance

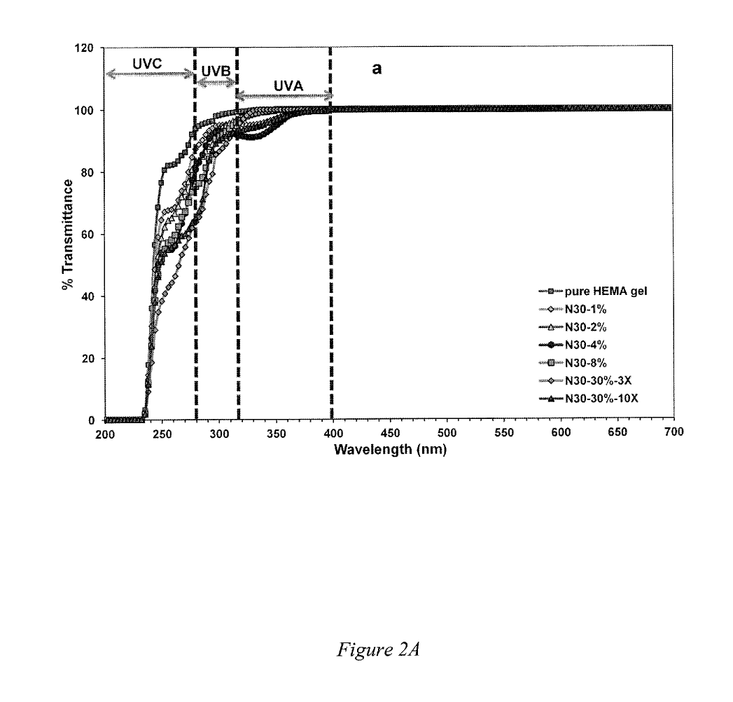

FIG. 2 shows the transmittance spectra of hydrated 100 μM thick gels for wavelengths ranging from 200-700. The lenses are identified by the name of surfactant followed by the weight ratio of the surfactant and HEMA in the formulation. The visual clarity was characterized by calculating the average transmittance for 600-700 nm range (Table 2). Table 2 also shows the average transmittance values for UVA (315-400 nm) and UVB (280-315 nm) radiation. All lenses transmit about 100% of the light in the visible and UVA spectrum. The UVB transmittance decreases significantly on surfactant incorporation, which is an additional benefit because UV radiation has the potential to cause ocular damage. The molar absorptivity of the surfactants was obtained by measuring the absorbance in aqueous solutions at 0.01% (w/w). The surfactant concentration in each gel was then obtained by fitting the absorbance spectra A(□) to the Beer Lambert law, i.e., A=A_{HEMA}+ε(λ)cl using a least square fit. The fitted value of the concentration was used to determine the fractional conversion, i.e., the ratio of the surfactant concentration in the gels after the extraction and the originally loaded concentration. The % conversions reported in Table 2 depend strongly on the type of the surfactant. The conversions for the N30 surfactant decrease with increasing surfactant concentration ranging from about 18 to 4% for initial loadings of 1 and 30%, respectively. For the N10 surfactant, the conversion appears to relatively constant at about 29% for initial loadings varying from 3.5 to 15%. It was not feasible to reliably calculate the surfactant concentration in gels with higher loadings because the transmittance increases very rapidly from 0 to 100% over a short wavelength range and the approach of determining the concentration loses sensitivity. The conversions are higher for the N10 compared to the N30 most likely due to the stearic effects of the longer hydrophilic chain. The conversions for the H30 surfactants are even lower than the N30, which shows that the end group capping the hydrophilic chain significantly impacts the reactivity of the surfactant monomer. Since the conversions are very low for the H30 gels, these were not included in any of the characterization studies described below. The low conversions in general suggest that the reactivity of the vinyl group in these surfactants is lower than the reactivity in HEMA.

TABLE 2
% Transmittance and % Conversion in surfactant loaded gels

| | Surfactant | Remaining | | | | | |
|---|---|---|---|---|---|---|---|
| | loading | surfactant | | | | | |
| | % * | % ** | | | | | |
| | Initial | After | Conversion | Mean Transmittance | | | |
| Gel | Formulation | Extraction | % | Visible | UVA | UVB | UVC |
| HEMA | 0 | 0 | | 100 | 100 | 97.45 | 38.58 |
| N30-1% | 0.637 | 0.117 | 18.38 | 100 | 98.36 | 94.67 | 33.98 |
| N30-2% | 1.244 | 0.189 | 15.19 | 100 | 99.60 | 90.60 | 30.98 |
| N30-4% | 2.438 | 0.282 | 11.58 | 100 | 96.79 | 91.16 | 28.68 |
| N30-8% | 4.652 | 0.290 | 6.23 | 100 | 98.72 | 87.35 | 28.37 |
| N30-30%-3X | 13.15 | 0.556 | 4.23 | 100 | 100 | 82.43 | 22.52 |
| N30-30%-10X | 14.76 | 0.316 | 2.14 | 100 | 97.81 | 86.08 | 26.55 |
| N10-3.5% | 2.165 | 0.634 | 29.29 | 100 | 97.05 | 58.92 | 11.22 |
| N10-8% | 4.561 | 1.290 | 28.27 | 100 | 95.68 | 36.82 | 5.18 |
| N10-15%-3X | 7.888 | 2.433 | 30.85 | 100 | 88.38 | 18.69 | 2.23 |
| N10-30%-3X | 13.32 | n/a | | 100 | 86.02 | 0.41 | 0.20 |
| N10-50%-3X | 18.70 | n/a | | 100 | 83.32 | 4.82 | 0.52 |
| H30-2% | 1.228 | 0.065 | 5.30 | 100 | 100 | 95.18 | 34.66 |
| H30-8% | 4.632 | 0.275 | 5.94 | 99.81 | 97.54 | 86.18 | 27.84 |
| H30-30%-3X | 14.44 | 0.140 | 0.97 | 100 | 99.23 | 90.69 | 32.19 |

* on Hydrated wt. basis assuming 100% conversion for surfactant to polymer
** on Hydrated wt. basis

### Contact Angle

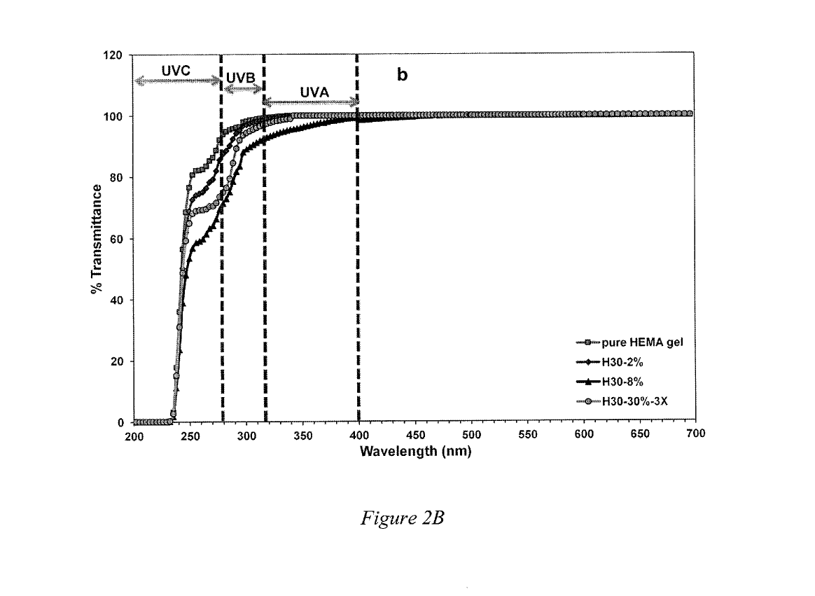

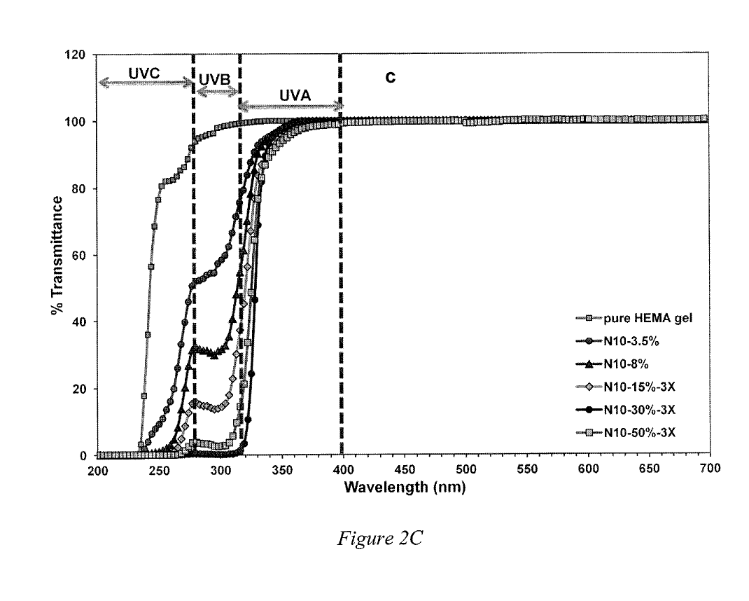

The contact angles of a water drop in contact with the gels are listed in Table 3 along with the equilibrium water content. Also some representative images of the sessile drops are included in FIG. 3. The results clearly demonstrate that surfactant incorporation in the lenses significantly reduces the contact angle from 90⁰ for p-HEMA gels to less than 10⁰ for the N10 gels with initial loadings of greater than 30%. For the N10-50% hydrogel, the contact angle could not be measured since the drop of water spread spontaneously into a thin film, implying a contact angle of about zero degree. To compare the effect of various surfactants, the contact angles for the various gels are plotted in FIG. 4 as a function of the moles of surfactant retained in the gel after the extraction. Since it was not possible to estimate the surfactant remaining for N10-30% gels, 29% conversion was assumed since that was the average conversion for the rest of gels containing N10. The data shows that the contact angle reduction is relatively independent of the surfactant type as the data for all the surfactants collapses on the same curve even though the N10 surfactants have a higher molar concentration due to the smaller molecular weight. The contact angle decreases with increasing surfactant concentration, but the rate of the decrease becomes smaller with increasing loadings, possibly due to saturation of the surface active groups at the surface. The on-eye contact angles are expected to be lower than the in vitro measurements because adsorption of the tear components (lysozyme and lipids) can lead to reduction of contact angle.

### Modified Commercial Contact Lenses

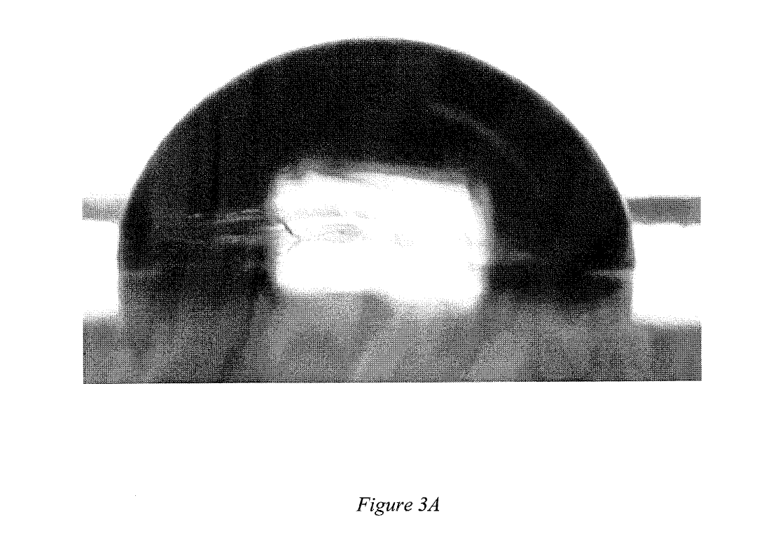

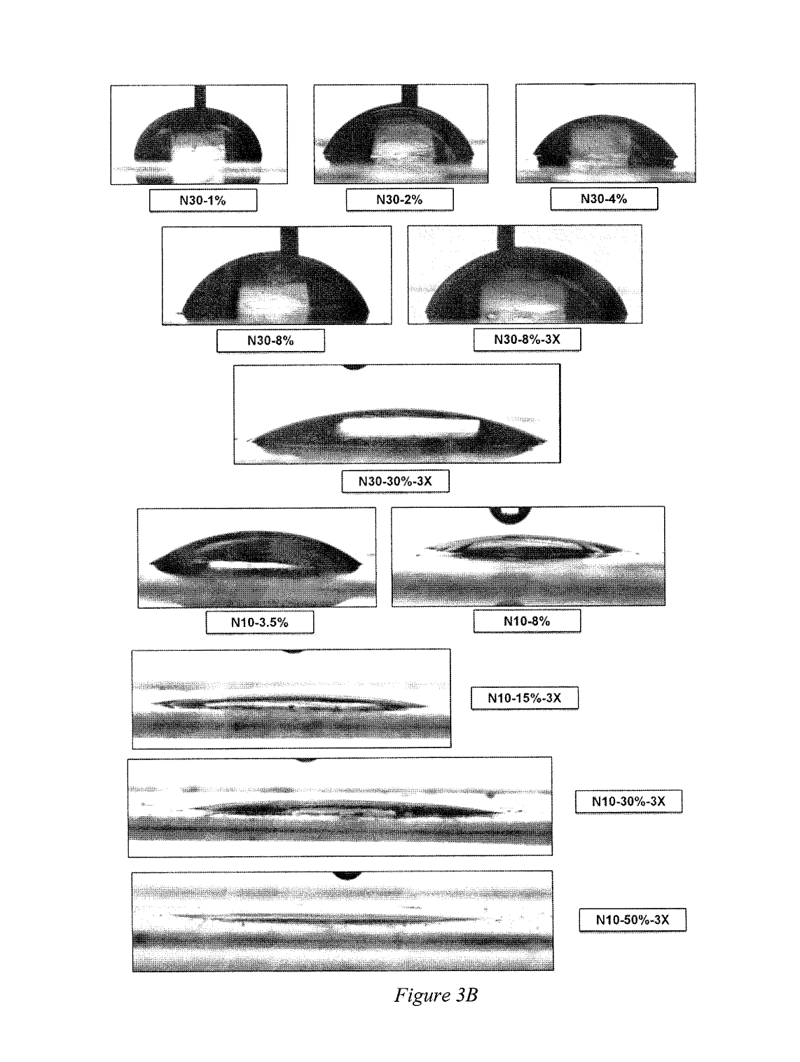

FIGS. 5 and 6 show images of a drop of water deposited on the surface of commercial contact lenses to measure the contact angle. The two images in FIG. 5 compare unmodified (left) and modified (right) 1 Day Avucue (hydrogel) lenses while the two images in FIG. 6 compare the unmodified and modified Acuvue TruEye (silicone hydrogel) lens. The images clearly demonstrate that incorporating the surfactant reduces the contact angle to almost zero degree.

### Surface Friction

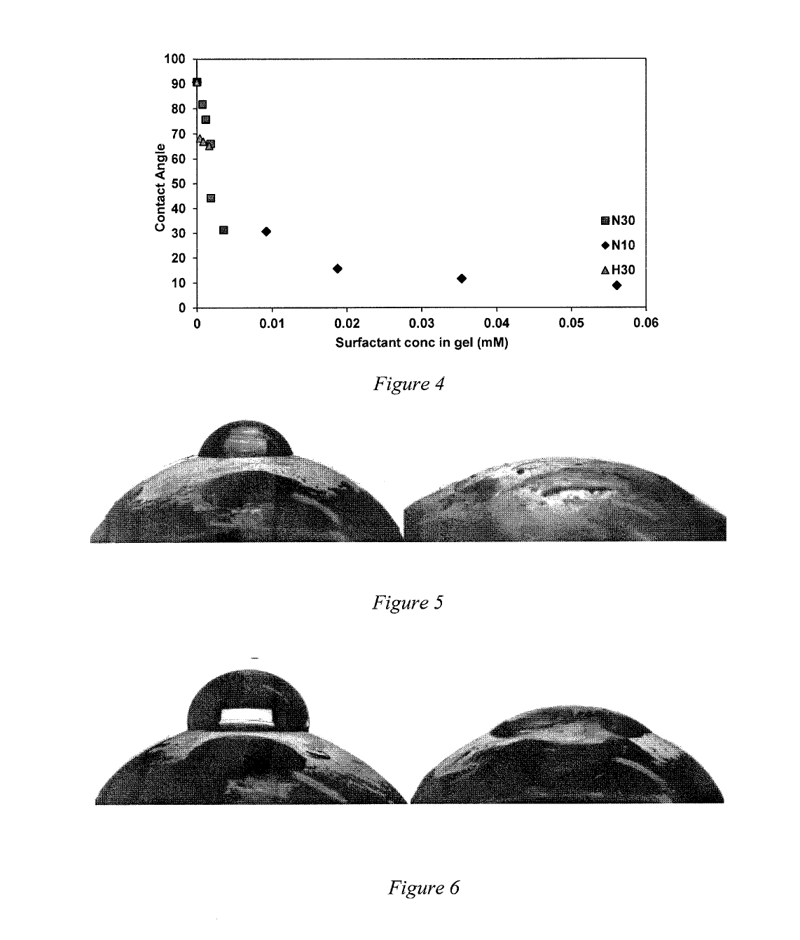

The coefficient of friction between a metal ball and the hydrated hydrogels are listed in Table 3 along with the concentrations of surfactant in the gels and the water content. The coefficient of friction is significantly lower for the surfactant loaded gels compared to the p-HEMA gel. The N30 gel with 0.19% surfactant (2% in the formulation) has a friction coefficient of 0.097 compared to 0.162 for the HEMA gel. The N10 gel with 0.56% surfactant (3.5% in the formulation) also has a significantly smaller coefficient of 0.065. A plot of the friction coefficient and the surfactant concentration in the gel shows that friction decreases rapidly with surfactant incorporation but the rate of decrease becomes smaller at high concentrations (FIG. 7). This behavior is similar to the effect of surfactant on the contact angle suggesting that the contact angle and the friction coefficient are correlated. However it is difficult to accurately assess the correlation between the contact angle and friction coefficient because the sensitivity of the friction measurements is low.

TABLE 3
Effect of surfactant incorporation on contact angle, coefficient
of friction and water content

| | Surfactant | Water | Contact | |
|---|---|---|---|---|
| | Conc. | Content | Angle | Surface |
| Gel | mM | % | deg | Friction |
| p-HEMA | 0.00000 | 35.96 ± 0.14 | 90.7 ± 1.3 | 0.162 ± 0.027 |
| N30-1% | 0.00075 | 35.67 ± 0.15 | 81.8 ± 3.2 | 0.113 ± 0.016 |
| N30-2% | 0.00120 | 36.56 ± 0.30 | 75.7 ± 6.2 | 0.097 ± 0.007 |
| N30-4% | 0.00180 | 36.60 ± 0.54 | 66.0 ± 7.1 | 0.102 ± 0.018 |
| N30-8% | 0.00185 | 37.20 ± 0.47 | 44.3 ± 15.8 | 0.103 ± 0.018 |
| N30-30% | 0.00354 | 43.02 ± 0.35 | 31.3 ± 10.8 | 0.113 ± 0.016 |
| N30-30%- | 0.00201 | 36.03 ± 0.58 | 28.1 ± 6.8 | 0.085 ± 0.017 |
| 10X | | | | |
| N10-3.5% | 0.00921 | 35.97 0.50 | 30.7 ± 7.7 | 0.065 ± 0.018 |
| N10-8% | 0.01872 | 38.42 ± 1.16 | 15.7 ± 3.9 | 0.054 ± 0.015 |
| N10-15% | 0.03531 | 39.53 ± 0.25 | 11.6 ± 3.9 | 0.056 ± 0.017 |
| N10-30% | 0.05647* | 42.26 ± 0.22 | 8.8 ± 2.9 | 0.045 ± 0.014 |
| N10-50% | n/a | 43.90 ± 0.28 | n/a | 0.047 ± 0.015 |
| H30-2% | 0.00039 | 37.36 ± 0.91 | 68.3 ± 7.2 | 0.128 ± 0.025 |
| H30-8% | 0.00165 | 37.47 ± 0.25 | 65.2 ± 9.5 | 0.112 ± 0.020 |
| H30-30% | 0.00084 | 37.41 ± 0.38 | 67.0 ± 6.2 | 0.130 ± 0.023 |

*Under assumption of 29% conversion

### Water Content

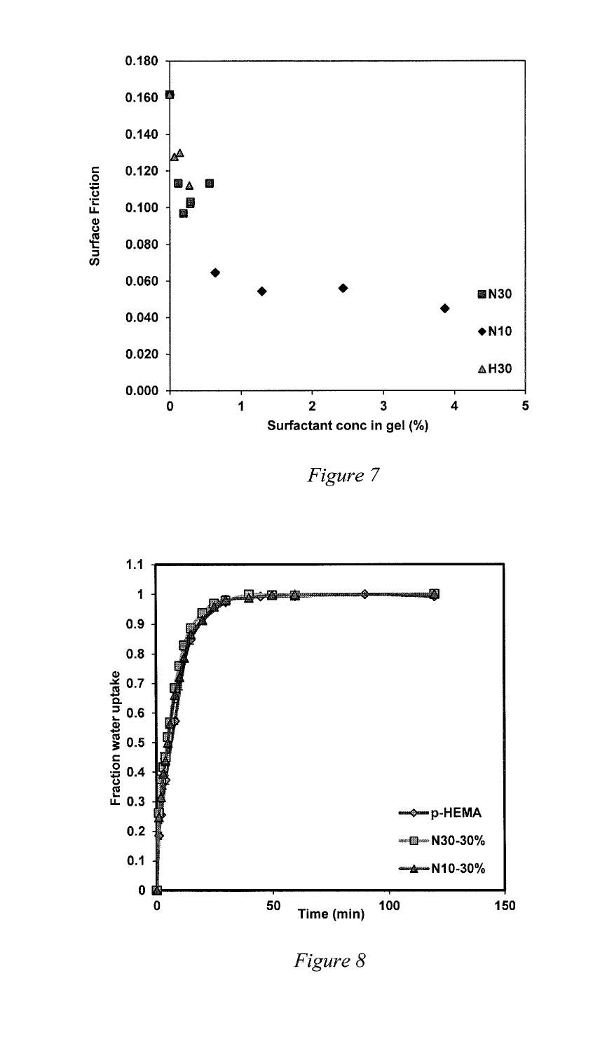

The water content increases on incorporation of the polymerizable surfactants, as shown in Table 3. The dynamics of water transport were also measured for a few of the systems and results plotted in FIG. 8 show that the water transport dynamics are not impacted by surfactant incorporation. These results indicate that the rate of water loss is correlated to the dryness sensation and water content in the p-HEMA gels is correlated to the oxygen permeability, and thus increasing water content without impacting the rates of transport is desirable.

### Mechanical Properties: Storage Modulus

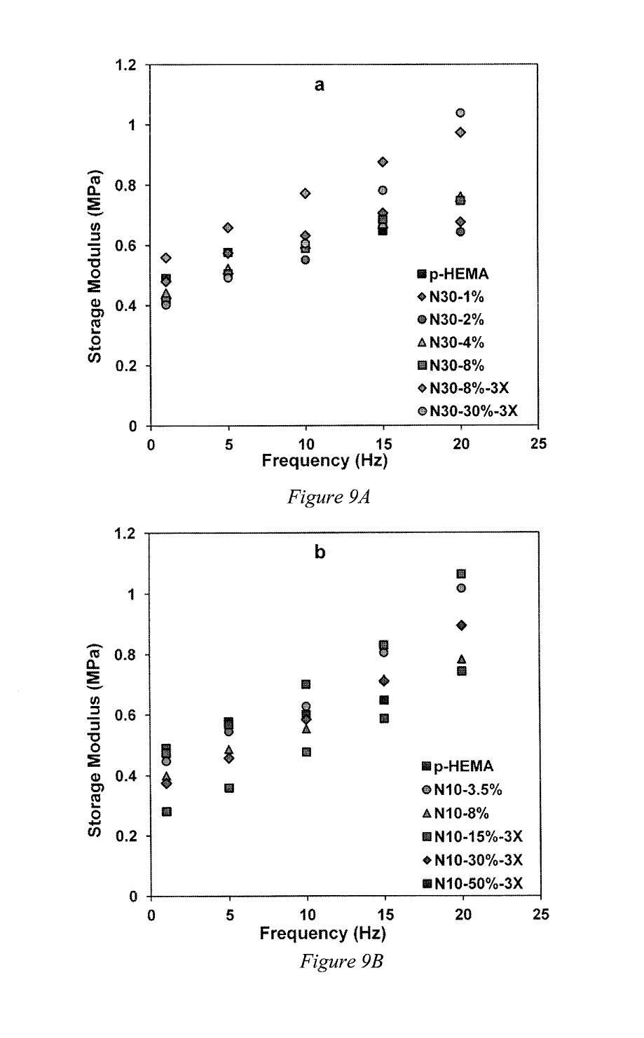

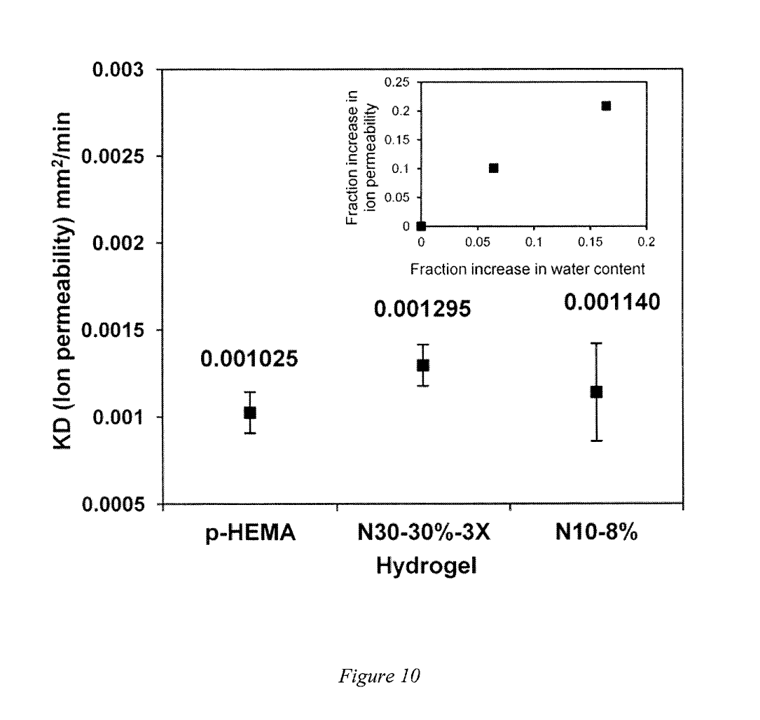

Incorporation of surfactants makes contact lenses softer, which could increase comfort but may also make contact lens insertion in the eye very difficult. The effect of surfactant incorporation on modulus was determined. The frequency dependent storage modulus is plotted in FIG. 9a and b for the N10 and N30 gels, and the zero-frequency intercepts are listed in Table 4. The loss modulus was also measured (data not shown). The degree of crosslinking is explicitly included in the lens description because of its strong impact on the moduli. 1× and 3× denoted 20 and 60 μl of EGDMA, respectively, in the formulation, while keeping amounts of all other components unchanged (Table 1). The results in FIG. 10 and in Table 4 show that the modulus slightly decreases with increasing surfactant incorporation likely due to the increased water content. The data also show that an increase in the degree of crosslinking increases the modulus, and thus it counteracts the effects of increasing surfactant loading.

TABLE 4
Zero-frequency storage modulus for the surfactant loaded gels

| Gel | Storage Modulus at 0 Hz |
|---|---|
| p-HEMA | 0.498 |
| N30-1% | 0.478 |
| N30-2% | 0.409 |
| N30-4% | 0.432 |
| N30-8% | 0.410 |
| N30-8%-3X | 0.546 |
| N30-30% | 0.330 |
| N10-3.5% | 0.390 |
| N10-8% | 0.375 |
| N10-15%-3X | 0.420 |
| N10-30%-3X | 0.329 |
| N10-50%-3X | 0.244 |

### Ion Permeability

A contact lens needs adequate transport of ions to maintain on-eye movement (ref). An increased crosslinking that is required to counteract the effect of decrease in modulus with surfactant incorporation could potentially reduce the ion permeability. To test this effect the ion permeability was measured for a few illustrative systems. The data in FIG. 8 show that both surfactant incorporation and increase in crosslinking have a minor effect on the ion permeability. The change in the ion permeability could be correlated to the change in water content as shown in the inset of the figure.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A hydrogel or silicone hydrogel device, comprising a polymerized surfactant, wherein the polymerized surfactant is attached on average by a single ethylenic group derived repeating unit within the gel network of a hydrogel or silicone hydrogel.

2. The device of claim 1, wherein the polymerized surfactant is a non-ionic surfactant.

3. The device of claim 2, wherein the non-ionic surfactant comprises a polyethylene oxide from a polymerizable surfactant with a single ethylenic unit attached thereto.

4. The device of claim 2, wherein the polymerizable surfactant is Noigen RN-10™ (N10), Noigen RN30™ (N30) and/or Hitenol BC30™ (H30).

5. The device of claim 1, wherein the polymerized surfactant further comprises a functionality that absorbs UVA and/or UVB radiation.

6. The device of claim 1, wherein the hydrogel or silicone hydrogel comprises a contact lens.

7. A method of preparing a wettable hydrogel or silicone hydrogel device comprising:
providing a monomer mixture polymerizable to a hydrogel or silicone hydrogel comprising at least one polymerizable surfactant, wherein the polymerizable surfactants comprise on average one ethylenic unit;
adding a radical initiator to the monomer mixture;
radically polymerizing the monomer mixture to a hydrogel or silicone hydrogel device on a surface or within a mold; and
removing the hydrogel or silicone hydrogel device from the surface or from the mold.

8. The method of claim 7, wherein all of the polymerizable surfactants have only one ethylenic unit.

9. The method of claim 8, wherein the polymerizable surfactant is Noigen RN-10™ (N10), Noigen RN30™ (N30) and/or Hitenol BC30™ (H30).

10. A method of preparing a wettable hydrogel or silicone hydrogel device comprising:
providing a hydrogel or silicone hydrogel device;
providing at solution comprising at least one polymerizable surfactant, wherein the polymerizable surfactants comprise on average one ethylenic unit;
providing a radical initiator;
combining the hydrogel or silicone hydrogel device, the solution of least one polymerizable surfactant and the radical initiator;
radically polymerizing the polymerizable surfactant and available ethylenic units in the hydrogel or silicone hydrogel device; and
removing the hydrogel or silicone hydrogel device from the solution.

11. The method of claim 10, wherein the polymerizable surfactant is Noigen RN-10™ (N10), Noigen RN30™ (N30) and/or Hitenol BC30™ (H30).

12. The method of claim 10, wherein the solution further comprises water.

13. The method of claim 12, wherein the solution further comprises ethanol.

14. The method of claim 10, wherein the hydrogel or silicone hydrogel device comprises a contact lens.
